(19) United States
(12) Patent Application Publication
(10) Pub. No.: US 2010/0124210 A1
(43) Pub. Date: May 20, 2010

(54) METHOD AND SYSTEM FOR RF TRANSMITTING AND RECEIVING BEAMFORMING WITH GPS GUIDANCE

(75) Inventor: CHUNG-WEN (DENNIS) LO, PALO ALTO, CA (US)

Correspondence Address: Sawyer Law Group, P.C., P.O. Box 51418, Palo Alto, CA, 94303, US

(73) Assignee: RALINK TECHNOLOGY CORPORATION, CUPERTINO, CA (US)

(21) Appl. No.: 12/271,799

(22) Filed: Nov. 14, 2008

(51) Int. Cl. H04W 76/00

(52) U.S. Cl. 370/338

(57) ABSTRACT

A method for radio frequency transmitting and receiving beamforming using both GPS guidance and wireless access points is disclosed. The method comprises providing a wireless networking device with preloaded wireless access point locations; calculating a relative vector to an access point based upon at least one of the preloaded wireless access point locations; steering a transmitted beam with a sounding packet to the access point; calculating a channel condition by the access point; and sending a packet by the access point to the wireless networking device to establish a connection.

### FIELD OF THE INVENTION

The present invention relates generally to wireless systems and more specifically to wireless systems with beamforming capability

### BACKGROUND OF THE INVENTION

In computer networking, a wireless access point or a base station is a device that allows wireless communication devices to connect to a wireless network such as wireless local area network (WLAN) or wireless metropolitan area network (WMAN) or other related standards. The access point or base station usually connects to a wired network, and can relay data between the wireless devices (such as computers or printers) and wired devices on the network (Wikipedia—http://en.wikipedia.org/wiki/Wireless_access_point)

Global positioning system (GPS) has been widely used in portable devices such as cellular phones, MP3 players and in automobiles. Today, WLAN devices are often embedded in these and countless other portable devices.

Beamforming is a signal processing technique used in sensor arrays for directional signal transmission or reception. (http://en.wikipedia.org/wiki/Beamforming) In wireless devices, beamforming utilizing multiple antenna or multiple transceivers has been used as one means to increase signal strength and hence range in one or several desired directions. Historically, many methods have been utilized to perform beamforming in order to establish an initial connection. One traditional technique involves the use of DSP Processors and FPGA chips to search in various patterns. However, this technique is known to incur high development costs.

Another common approach to beamforming requires the use of a conventional isotropic signal in order to establish the initial connection and then perform the beamforming to increase signal to noise ratio. Under this method, as the range increases, the signal to noise ratio begins to decline which directly results in decreased performance. Hence, performance using the conventional isotropic signal is limited by the isotropic range.

A third approach to beamforming involves the use of multiple antennas and multiple transceivers as a way of increasing signal strength, and hence, the signal range. However, since the location of the link to be formed is unknown, there are often failed connections since the link location is too far away and not reachable. Therefore, this method proves to be both time-consuming and inefficient since the non-guided beams are either received in the wrong places, or not received at all.

Accordingly, what is needed is a method of transmitting and receiving beamforming that overcomes the above-described operational issues. The method should be cost-effective, easily implemented, efficient, and have good performance characteristics. The present invention addresses such a need.

### SUMMARY OF THE INVENTION

The present invention satisfies this need, and presents a method and system for radio frequency transmitting and receiving beamforming using preloaded locations of wireless access points. To achieve the above object, the present method is described as: providing a wireless networking device with a plurality of preloaded wireless access point locations; calculating a relative vector to an access point based upon at least one of the preloaded wireless access point locations; steering a transmitted beam with a sounding packet to the access point; calculating a channel condition by the access point; and sending a packet by the access point to the wireless networking device to establish a connection. One advantage of a system and method in accordance with the present invention is that the beamforming is transmitted with known direction by the calculated relative vector. This allows for a more efficient connection because with conventional methods the transmitted signal would either not be received at all, or would be received as a weak signal resulting in low throughput. A second advantage of a system and method in accordance with the present invention is the fact that both the range and signal throughput are increased since the location of the access point is predetermined.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1a illustrates a wireless networking device system.

FIG. 1b is an illustration of the communication that occurs between the wireless networking device system and the access point.

FIG. 2 is an illustration of the calculated relative vector to the access point as determined by the wireless networking device.

FIG. 3 is a flowchart that describes the negotiation process between the wireless networking device and an access point to establish a connection.

FIG. 4 illustrates the range of both conventional and GPS-assisted beamforming techniques.

### DETAILED DESCRIPTION

The present invention relates generally to wireless systems and more specifically to wireless systems with beamforming capability. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

A method and system in accordance with the present invention uses a wireless networking device with preloaded wireless access point locations and calculates a relative vector to an access point based on at least one of the preloaded wireless access point locations. A transmitting beam and a sounding packet are steered toward the access point and finally, a packet is sent by the access point to the wireless networking device to establish the desired connection. The method and system in accordance with the present invention has many advantages which are described hereinbelow.

A method and system that utilizes a wireless networking device with preloaded wireless access points in accordance with the present invention can take the form of an entirely hardware implementation, an entirely software implementation, or an implementation containing both hardware and software elements. In one implementation, this disclosure is implemented in software, which includes, but is not limited to, application software, firmware, resident software, microcode, etc.

Furthermore, the method and system that utilizes a wireless networking device with preloaded wireless access points can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W). To describe the features of the present invention in more detail, refer now to the following description in conjunction with the accompanying Figures.

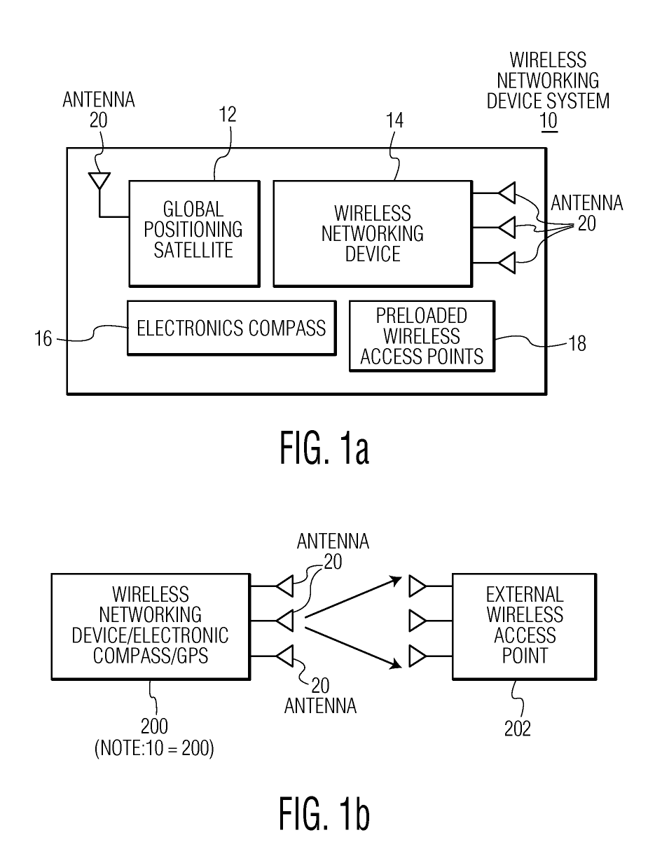

FIG. 1a illustrates a wireless networking device system 10 in accordance with an embodiment. The system 10 includes a wireless networking device 14, a global positioning system (GPS) 12, and an electronic compass 16. In addition, the system also includes preloaded wireless access points 18. Preloaded wireless access points 18 consist of a plurality of access points at numerous locations wherein such access points may be communicated with by the wireless device system 14.

FIG. 1b illustrates the communication that occurs between the wireless networking device system 14′ and an access point 202. The preloaded wireless access points 18′ correspond to the access points 202 in a particular area. In advance, the wireless networking device system 14′ would have stored the location of these access points 202 in a particular memory format such as random access memory, read-only memory, or the like.

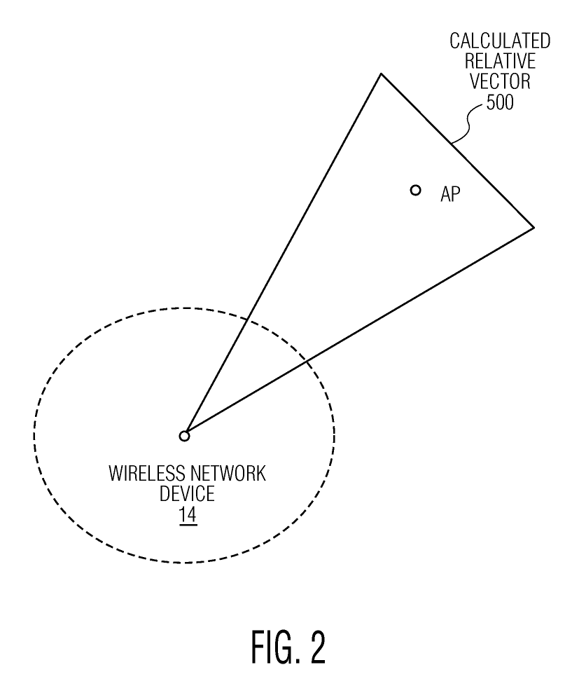

For example, if an automobile traveling in San Francisco were equipped with such a wireless networking device 14′, the wireless networking device 14′ within the automobile would have the locations of the particular preloaded wireless access point locations 18′ throughout San Francisco stored within its memory. One such location of a preloaded wireless access point 18′ may be Coit Tower, for example. The wireless networking device system 14′ within the automobile would communicate with the preloaded wireless access point 18′ to identify the access point 202 that corresponds to Coit Tower. Next, the wireless networking device system 14′ would determine if the access point 202 within Coit Tower was available (i.e. the channel is clear) and able to accommodate such a connection (as described infra in FIGS. 2-4).

FIG. 2 is an illustration of a calculated relative vector 500 to an access point 202 as determined by the wireless networking device 14′.

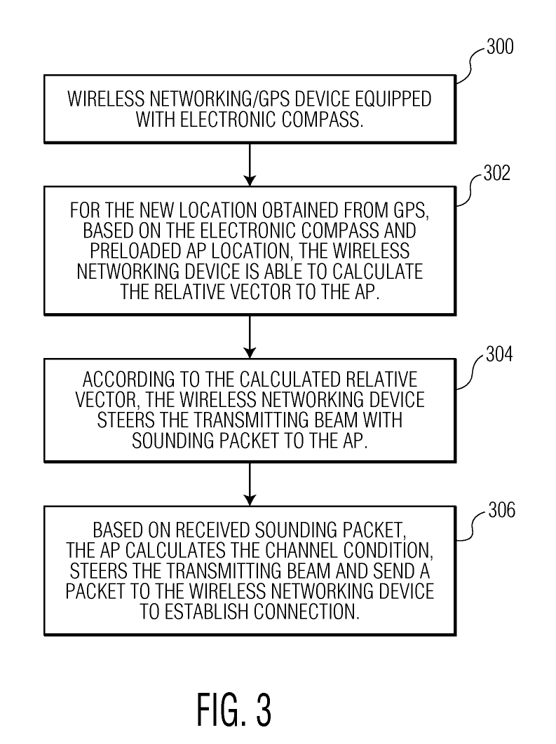

FIG. 3 is a flowchart that describes the negotiation process between the wireless networking device 14 and the access point 202 to establish a connection. First, the wireless networking device 14 communicates with an electronic compass 16, the GPS 12, and preloaded wireless access points 18 to ascertain the location of a wireless access point, via step 300. Next, referring to FIGS. 2 and 3 together, the access point location 202 is determined as the wireless networking device 14 calculates a relative vector to the access point 500, via step 302. In step 304, according to the calculated relative vector to the access point 500, the wireless networking device 14 steers the transmitting beam and a sounding packet to the access point 202.

The sounding packet may include multiple frames including Legacy Short Training Frames (L-STF), Legacy Long Training Frames (L-LTF), Legacy Signaling Frames (L-SIG), High-Throughput Long Training Frames (HT-LTF), and data (HT-DATA). The Legacy frames refer to frames according to previous versions of the IEEE 802.11 standard. The High-Throughput refers to frames according to draft IEEE 802.11n standard specifications currently being developed and regarding which a draft document titled “PHY subsection Tech Spec 889r7” including a recent version of the specifications is incorporated herein by reference, and within which certain features of the present invention would preferably be incorporated. Such sounding packets are described, for example in patent application no. US2008/0212538 A1, entitled “Antenna Selection for Multi-Input Multi-Output System”.

Finally, based on the received sounding packet, the access point 202 calculates the channel condition, steers the transmitting beam, and sends a packet (not shown) to the wireless networking device 14 to establish the connection, via step 306.

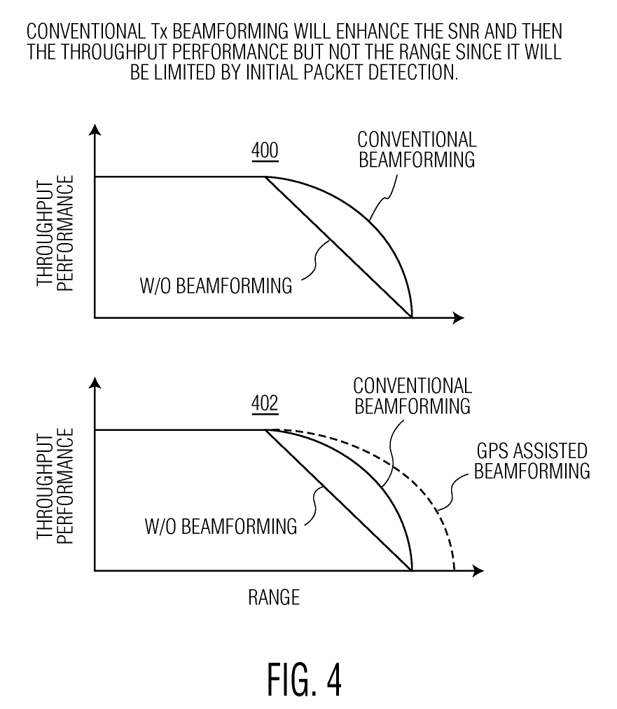

FIG. 4 illustrates the performance characteristics of both a conventional and a beamforming technique in accordance with the present invention. The first waveform 400 shows that conventional beamforming techniques may enhance the signal to noise ratio (SNR) which thereby increases only the throughput performance. However, there is no impact to the range since the range is limited by the initial packet detection.

By contrast, the second waveform 402 shows that the beamforming technique poses a significant advantage over the conventional beamforming technique. The advantage is due to the range of the wireless device which is increased due to both the calculated relative vector to the access point and the known direction of the transmitted beam based on the preloaded wireless access point location. Thus, the beamforming technique of the present invention allows both the SNR and the range to be enhanced substantially.

Although the present invention has been described in accordance with the embodiments shown, one of ordinary skill in the art will readily recognize that there could be variations to the embodiments and those variations would be within the spirit and scope of the present invention.

Accordingly, many modifications may be made by one of ordinary skill in the art without departing from the spirit and scope of the appended claims.

What is claimed is:

1. A method for using beamforming to establish a wireless connection, comprising:
providing a wireless networking device with a plurality of preloaded wireless access point locations;
calculating a relative vector to an access point based upon at least one of the preloaded wireless access point locations;
steering a transmitted beam with a sounding packet to the access point;
determining a channel condition by the access point based upon the received channel condition; and
sending a packet by the access point to the wireless networking device to establish a connection if the channel condition is acceptable.

2. The method of claim 1 further including:
providing the wireless networking device with a global positioning system (GPS) and an electronic compass.

3. The method of claim 2 further including:
calculating the relative vector utilizing the compass and the GPS to establish the wireless networking device location.

4. The method of claim 1 wherein steering the transmitting beam comprises initiating a searching algorithm based on the calculated relative vector.

5. A computer readable medium containing programming instructions for using beamforming to establish a wireless connection, the instructions being executable for:
providing a wireless networking device with a plurality of preloaded wireless access point locations;
calculating a relative vector to an access point based upon at least one of the preloaded wireless access point locations;
steering a transmitted beam with a sounding packet to the access point;
determining a channel condition by the access point based upon the received channel condition; and
sending a packet by the access point to the wireless networking device to establish a connection if the channel condition is acceptable.

6. The computer readable medium of claim 5 further including the instructions for:
providing a wireless networking device with a global positioning system (GPS) and an electronic compass.

7. The computer readable medium of claim 5 further including the instructions for:
calculating a relative vector utilizing a compass and a GPS to establish the wireless networking device location.

8. The computer readable medium of claim 5 further including the instructions for:
initiating a searching algorithm based on the calculated relative vector.

9. A system comprising:
a wireless networking device for receiving and transmitting information;
an electronic compass;
a global positioning system (GPS); and
a plurality of preloaded wireless access point locations, wherein the GPS, electronic compass, and preloaded wireless access point locations work in cooperation to identify at least one access point for a connection.

10. The system of claim 9 wherein upon receiving the information regarding each new access point, the wireless networking device calculates a relative vector to the access point;
wherein based on the relative vector to the access point, the wireless networking device steers a transmitting beam and a sounding packet to the access point; wherein the access point sends a packet to the wireless networking device and a connection is thereby established.
